(19) United States
(12) Patent Application Publication
(10) Pub. No.: US 2025/0013733 A1
(43) Pub. Date: Jan. 9, 2025

(54) INFORMATION PROCESSING SYSTEM, NON-TRANSITORY COMPUTER READABLE MEDIUM, AND METHOD

(71) Applicant: FUJIFILM Business Innovation Corp., Tokyo (JP)

(72) Inventor: Hirotaka KAWABATA, Kanagawa (JP)

(73) Assignee: FUJIFILM Business Innovation Corp., Tokyo (JP)

(21) Appl. No.: 18/434,723

(22) Filed: Feb. 6, 2024

(30) Foreign Application Priority Data
Jul. 6, 2023 (JP) 2023-111630

(51) Int. Cl. G06F 21/51; G06F 21/57

(52) U.S. Cl. CPC G06F 21/51; G06F 21/575

(57) ABSTRACT

An information processing system includes one or more processors configured to: classify multiple modules as at least one first module or at least one second module, the multiple modules being included in the information processing apparatus, the at least one first module being required to perform a predetermined process within a predetermined time after activation triggered by reception of a signal from the outside, the at least one second module being not required to perform the process within the time; and after completion of confirming that the at least one first module does not fail in integrity check and the at least one first module performing the process, confirm that the at least one second module does not fail in integrity check.

### CROSS-REFERENCE TO RELATED APPLICATIONS

This application is based on and claims priority under 35 USC 119 from Japanese Patent Application No. 2023-111630 filed Jul. 6, 2023.

### BACKGROUND

### (i) Technical Field

The present disclosure relates to an information processing system, a non-transitory computer readable medium, and a method.

### (ii) Related Art

A technique which enables operations of an image processing apparatus to be performed remotely from a mobile terminal is known. In the technique, the mobile terminal is connected to the image processing apparatus such as a so-called multifunction device, for example, which enables a document to be read and printed (for example, Japanese Unexamined Patent Application Publication No. 2022-066044).

In such a technique, an operation of detecting an integrity check failure is performed on each module that is to be activated. Thus, time required until all the modules are activated is longer than in the case without execution of the process of detecting an integrity check failure. As a result, among the modules included in the information processing apparatus, a module which performs a process having time limitation may fail to complete its execution within the time limit.

### SUMMARY

Aspects of non-limiting embodiments of the present disclosure relate to a technique which enables completion, within a time limit, of the following processes: detecting whether modules, which perform processes having time limitation, have failed in integrity check; and performing the processes by the modules.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising: one or more processors configured to: classify a plurality of modules as at least one first module or at least one second module, the plurality of modules being included in the information processing apparatus, the at least one first module being required to perform a predetermined process within a predetermined time after activation triggered by reception of a signal from an outside, the at least one second module being not required to perform the process within the time; and after completion of confirming that the at least one first module does not fail in integrity check and the at least one first module performing the process, confirm that the at least one second module does not fail in integrity check.

### BRIEF DESCRIPTION OF THE DRAWINGS

Exemplary embodiments of the present disclosure will be described in detail based on the following figures, wherein:

FIG. 1 is a diagram illustrating an exemplary entire configuration of an information processing system, to which the present exemplary embodiment is applied;

FIG. 2 is a diagram illustrating an exemplary hardware configuration of an image processing apparatus;

FIG. 3 is a diagram illustrating an exemplary functional configuration of a controller of an image processing apparatus;

FIGS. 4A and 4B are a flowchart of a process of an image processing apparatus;

FIG. 5 is a diagram illustrating a concrete example of timing of reception/transmission of various signals, which is performed until start of reception/transmission of a facsimile document between an image processing apparatus and a telephone exchange;

FIG. 6A is a diagram illustrating an example of the related art, in which a fax function module component, which is constituted by multiple modules, is not classified;

FIG. 6B is a diagram illustrating a concrete example of the case in which a fax function module component, which is constituted by multiple modules, is classified as first modules or second modules; and

FIG. 7 is an image view of a concrete example of the case in which an image processing apparatus includes multiple fax cards.

### DETAILED DESCRIPTION

Referring to the attached drawings, an exemplary embodiment of the present disclosure will be described in detail below.

### The Configuration of an Information Processing System

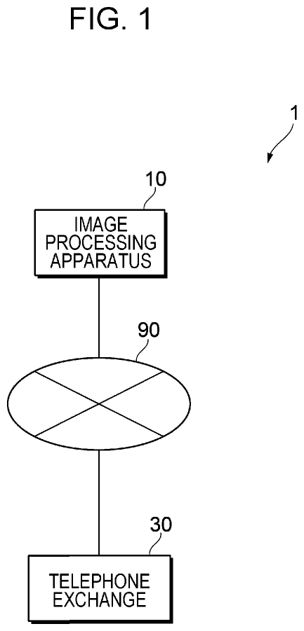

FIG. 1 is a diagram illustrating an exemplary entire configuration of an information processing system 1, to which the present exemplary embodiment is applied.

The information processing system 1 includes an image processing apparatus 10 and a telephone exchange 30 which are connected over a network 90. Examples of the network 90 include a public line network, a local area network (LAN), and the Internet.

### The Image Processing Apparatus

The image processing apparatus 10 is an information processing apparatus which performs various types of processing in accordance with input operations performed by users who use the information processing system 1. For example, the image processing apparatus 10 performs a process of forming an image on a medium such as a sheet, a process of outputting a recording medium on which an image is formed, a process of reading an image formed, for example, on a sheet, a process of transmitting by facsimile a read image, and a process of acquiring various types of information transmitted from the outside. Examples of the image processing apparatus 10 include a so-called electrophotographic-system multifunction device which forms a toner image on a print surface of a sheet, and a so-called inkjet-system printer which ejects ink onto a print surface of a sheet.

The image processing apparatus 10 stores and manages various types of information in a database. The image processing apparatus 10 acquires various types of information transmitted from the telephone exchange 30 over the network 90, and performs various types of processing. The image processing apparatus 10 transmits various types of information to the telephone exchange 30.

For example, the image processing apparatus 10 classifies multiple modules included therein. “Modules” refer to components obtained when hardware is split in accordance with each function. The image processing apparatus 10 classifies the modules as first modules or second modules. A “first module” refers to a module required to perform a predetermined process within a predetermined time (hereinafter called a “time limit”) after activation performed in response to reception of a signal from the telephone exchange 30. A “second module” refers to a module which is not required to perform a predetermined process within a time limit. In the present exemplary embodiment, a “predetermined process” performed by a first module is a process of responding to the telephone exchange 30. A process performed by a first module is not limited to a process which is required to be performed within a time limit, and may encompass a process other than this.

In the present exemplary embodiment, the image processing apparatus 10 includes hardware (hereinafter called a “fax card”) which enables a facsimile document to be received/transmitted. The image processing apparatus 10 classifies the firmware of the fax card as a boot loader, which activates the operating system, or modules for receiving/transmitting a facsimile document (hereinafter called a “fax function module component”). The image processing apparatus 10 further classifies the fax function module component, which is constituted by the multiple modules, as first modules or second modules.

Modules classified as first modules include, for example, a module, which transmits a primary response signal within a time limit, as a process of responding to an information-receiving-terminal activation signal (hereinafter called a “CAR signal”) from the telephone exchange 30. A CAR signal is a signal transmitted to check whether the reception side supports a so-called caller ID notification service. Modules classified as first modules also include a module which receives a modem signal transmitted from the telephone exchange 30 after transmission of a primary response signal, and a module which transmits, to the telephone exchange 30, a reception completion signal indicating that a modem signal has been received. A modem signal includes, for example, information such as a calling phone number. Modules classified as second modules include, for example, a module, which starts reception/transmission of a facsimile document after transmission of a secondary response signal, as a process of responding to a ringing signal (hereinafter called an “IR signal”) from the telephone exchange 30.

The image processing apparatus 10 confirms that modules included therein have not failed in integrity check. For example, when the firmware of the fax card included in the image processing apparatus 10 is classified as a boot loader, first modules, or second modules, the image processing apparatus 10 confirms that these have not failed in integrity check. Specifically, when power supply is turned ON in response to detection of arrival of a CAR signal, the fax card included in the image processing apparatus 10 checks whether the boot loader has not failed in integrity check. The method of a fax card detecting arrival of a CAR signal is not particularly limited. For example, a device such as a photocoupler may detect an incoming signal of a CAR signal.

When the fax card included in the image processing apparatus 10 confirms that the boot loader has not failed in integrity check, the fax card activates the boot loader. After the activation, the boot loader confirms that the first modules have not failed in integrity check, and activates the first modules. After the activation, the first modules transmit a primary response signal to the telephone exchange 30, as a process of responding to the CAR signal from the telephone exchange 30. After that, when a modem signal is transmitted from the telephone exchange 30, the first modules receive the modem signal, and transmit a reception completion signal to the telephone exchange 30. Then, the first modules confirm that the second modules have not failed in integrity check, and activate the second modules. That is, after completion of the process of transmitting a primary response signal, the first modules confirm that the second modules have not failed in integrity check. The expression, “completion of a process of transmitting a primary response signal”, means completion of a process in which, after the process of transmitting a primary response signal, a modem signal, which is transmitted on the basis of the process of transmitting the primary response signal, is received, and in which a reception completion signal is transmitted. After the activation, the second modules transmit a secondary response signal to the telephone exchange 30, as a process of responding to an IR signal from the telephone exchange 30, and start reception of a facsimile document. The configuration and the detailed process of the image processing apparatus 10 will be described below.

### The Telephone Exchange

The telephone exchange 30 is an apparatus which performs relaying on a public line network. The telephone exchange 30 reconnects lines in accordance with a process of transmitting a facsimile document, for transmission of a facsimile signal from the transmission source of the facsimile document to the fax card of the image processing apparatus 10 which is a connection destination.

The configuration of the information processing system 1 described above is exemplary. Any configuration may be employed as long as the information processing system 1, as a whole, includes the functions for implementing the processes described above. Thus, the information processing system 1 may be, alone or in cooperation with another system, in charge of some or all of the functions for implementing the processes described above. That is, some or all of the functions of the telephone exchange 30 may be delegated to the image processing apparatus 10, or some or all of the functions of the image processing apparatus 10 may be delegated to the telephone exchange 30. Further, a part or all of each function of the telephone exchange 30 and the image processing apparatus 10 which are included in the information processing system 1 may be delegated, for example, to another server (not illustrated). This enables the processing of the information processing system 1, as a whole, to be promoted, and enables each apparatus to complement processes of the other apparatuses.

### The Hardware Configuration of the Image Processing Apparatus

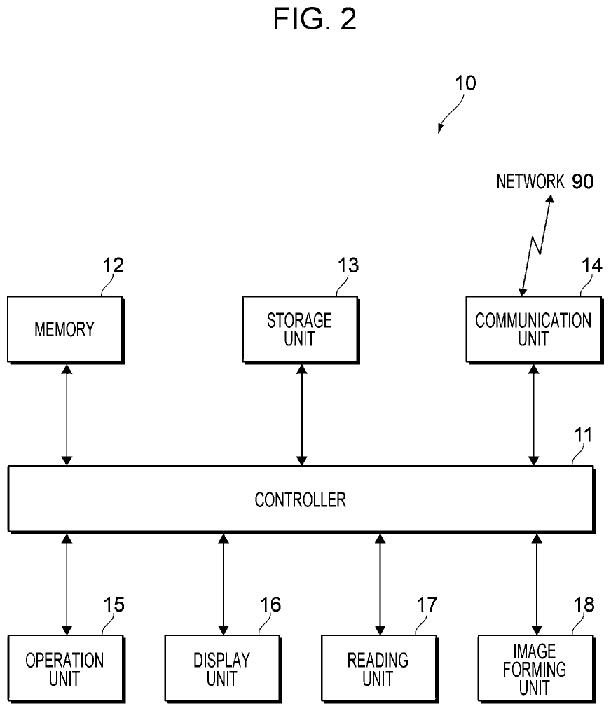

FIG. 2 is a diagram illustrating an exemplary hardware configuration of the image processing apparatus 10.

The image processing apparatus 10 includes a controller 11, a memory 12, a storage unit 13, a communication unit 14, an operation unit 15, a display unit 16, a reading unit 17, and an image forming unit 18. These units are connected to each other through a data bus, an address bus, a peripheral component interconnect (PCI) bus, and the like.

The controller 11 is a processor which controls functions of the image processing apparatus 10 through execution of various types of software, such as basic software (OS) and application software. The controller 11 is constituted, for example, by a central processing unit (CPU). The memory 12, which is a storage area in which various types of software, data used in execution of the software, and the like are stored, is used as a work area in computation. The memory 12 is constituted, for example, by a random access memory (RAM).

The storage unit 13 is a storage area in which data input to various types of software, data output from various types of software, and the like are stored. The storage unit 13 is constituted, for example, by a hard disk drive (HDD), a solid state drive (SSD), or a semiconductor memory, which is used to store programs, various types of setting data, and the like. The storage unit 13 stores a database storing various types of information.

The communication unit 14 receives/transmits data from/to the telephone exchange 30 and the outside over the network 90. The operation unit 15, which is constituted, for example, by a software keyboard, mechanical buttons, and switches, receives input operations. The operation unit 15 encompasses a touch sensor which constitutes a touch panel integrally with the display unit 16. The display unit 16, which is constituted, for example, by a liquid-crystal display or an organic light-emitting diode (OLED) display which is used to display information, displays data of images and text.

The reading unit 17 reads an image recorded on a medium (for example, a paper document) such as a sheet serving as a recording medium. The reading unit 17 is constituted, for example, by a charge-coupled device (CCD) scanner or a contact image sensor (CIS) scanner. For example, a CCD scanner reduces, by using a lens, reflected light obtained through reflection of light radiated from a light source to a document, and receives the reflected light with CCDs. A CIS scanner receives, with a CIS, reflected light obtained through reflection of light which is radiated from an LED light source to a document sequentially. The image forming unit 18 forms an image of a print target on a print surface of a sheet, which serves as a recording medium, for example, by using an electrophotographic system or an inkjet system. These units are connected to each other, for example, through a data bus, an address bus, and a PCI bus.

### The Hardware Configuration of the Telephone Exchange

The hardware configuration of the telephone exchange 30 is similar to the hardware configuration of the image processing apparatus 10, which is illustrated in FIG. 2, excluding the reading unit 17 and the image forming unit 18. That is, the telephone exchange 30 includes a controller, a memory, a storage unit, a communication unit, an operation unit, and a display unit which have substantially the same functions as those of the controller 11, the memory 12, the storage unit 13, the communication unit 14, the operation unit 15, and the display unit 16, which are illustrated in FIG. 2. The configuration of the telephone exchange 30 is neither illustrated nor described.

### The Functional Configuration of the Controller of the Image Processing Apparatus

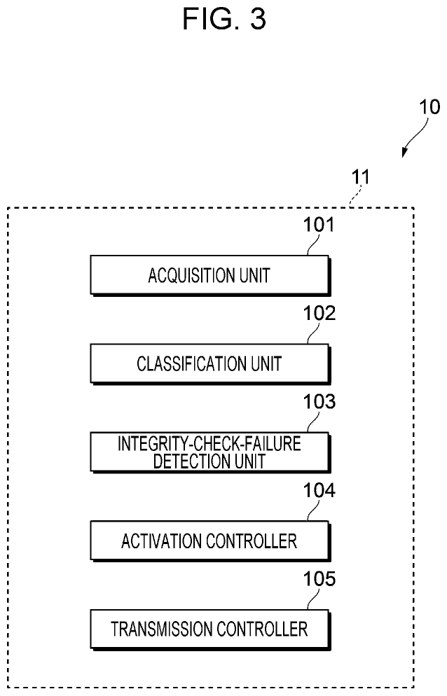

FIG. 3 is a diagram illustrating an exemplary functional configuration of the controller 11 of the image processing apparatus 10.

The controller 11 of the image processing apparatus 10 functions as an acquisition unit 101, a classification unit 102, an integrity-check-failure detection unit 103, an activation controller 104, and a transmission controller 105.

The acquisition unit 101 acquires various types of information. For example, the acquisition unit 101 acquires various types of information transmitted from the telephone exchange 30. Examples of information transmitted from the telephone exchange 30 include a CAR signal, an IR signal, and a facsimile document.

The classification unit 102 classifies modules included in the image processing apparatus 10. For example, the classification unit 102 classifies the modules as first modules or second modules. Specifically, for example, the classification unit 102 classifies the firmware of the fax card, which is included in the image processing apparatus 10, as a boot loader, which activates an operating system, or modules for reception/transmission of a facsimile document, and further classifies the modules for reception/transmission of a facsimile document as first modules or second modules.

The modules which are to be classified by the classification unit 102 may include a switching-settable module for which switching between execution as a first module or execution as a second module is settable. In this case, the classification unit 102 classifies a switching-settable module as either one of a first module and a second module on the basis of the setting state of switching.

The integrity-check-failure detection unit 103 detects an integrity check failure in modules included in the image processing apparatus 10. For example, when the fax card included in the image processing apparatus 10 detects arrival of a CAR signal, and then the power supply of the fax card is turned ON, the fax card, which functions as the integrity-check-failure detection unit 103, detects whether the boot loader has failed in integrity check. The fax card, which functions as the integrity-check-failure detection unit 103, detects whether the boot loader has failed in integrity check, without waiting for activation of the control board, the user interface panel, and the like.

When the boot loader, which it has been confirmed that does not fail in integrity check, is activated, the boot loader, which functions as the integrity-check-failure detection unit 103, detects whether the first modules have failed in integrity check. When the first modules, which it has been confirmed that do not fail in integrity check, are activated, the first modules, which function as the integrity-check-failure detection unit 103, detect whether the second modules have failed in integrity check.

When the activation controller 104 confirms that the integrity-check-failure detection unit 103 has not detected an integrity check failure, the activation controller 104 exerts control for activating various modules. For example, when the fax card confirms that the boot loader has not failed in integrity check, the fax card, which functions as the activation controller 104, exerts control for activating the boot loader. After the activation, the boot loader confirms that the first modules have not failed in integrity check, the boot loader, which functions as the activation controller 104, exerts control for activating the first modules. After the activation, the first modules confirm that the second modules have not failed in integrity check, the first modules, which function as the activation controller 104, exert control for activating the second modules.

The transmission controller 105 exerts control for transmitting various types of information through the communication unit 14 (see FIG. 2). Specifically, the transmission controller 105 exerts control for transmitting various types of information to the telephone exchange 30. For example, the fax card included in the image processing apparatus 10 functions as the transmission controller 105, and thus exerts control for transmitting, to the telephone exchange 30, information, such as a primary response signal and a secondary response signal.

### Process Flow

### Process Flow of the Image Processing Apparatus

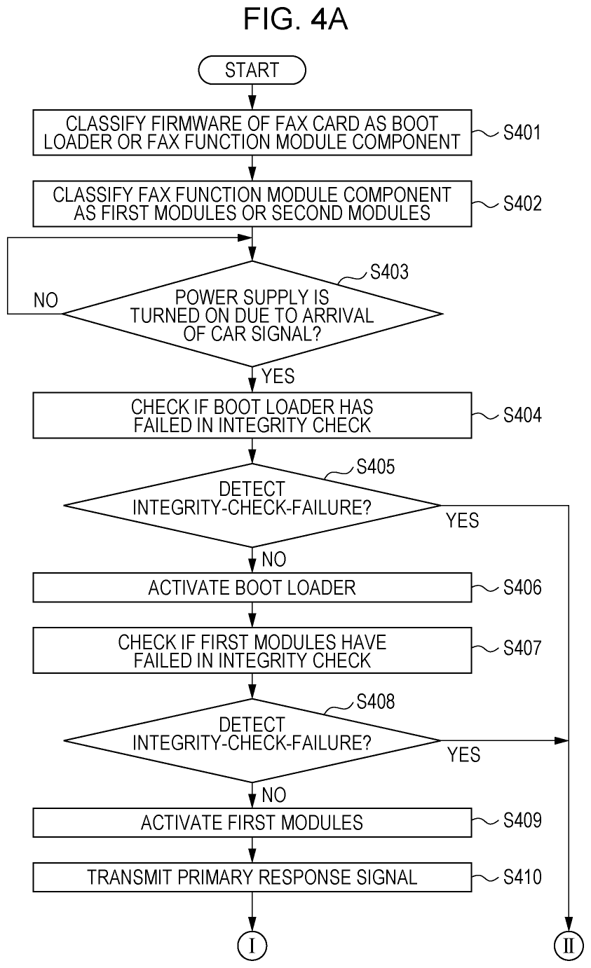

FIGS. 4A and 4B are a flowchart of an exemplary process of the image processing apparatus 10.

The image processing apparatus 10 classifies the firmware of the fax card, which is included therein, as a boot loader or a fax function module component (step 401). The image processing apparatus 10 classifies the fax function module component, which is constituted by the multiple modules, as first modules or second modules (step 402).

If the power supply of the fax card, which is included in the image processing apparatus 10, is turned ON due to arrival of a CAR signal (YES in step 403), the fax card checks if the boot loader has failed in integrity check (step 404). In contrast, if the power supply of the fax card has not been turned ON because a CAR signal has not arrived (NO in step 403), the fax card repeatedly performs the determination process in step 403 until the power supply is turned ON due to arrival of a CAR signal.

If the fax card detects an integrity check failure in the boot loader (YES in step 405), the fax card does not activate the boot loader, and notifies the integrity check failure (step 419). Then, the fax card ends the process (END). In contrast, if the fax card does not detect an integrity check failure in the boot loader (NO in step 405), the fax card activates the boot loader (step 406).

The method of notifying that the boot loader has failed in integrity check is not particularly limited. For example, in response to detection of an integrity check failure, an LED lamp of the fax card may be lit. Alternatively, for example, a message indicating an integrity check failure may be displayed on the display unit 16 of the image processing apparatus 10. Alternatively, for example, information about a module which is allowed to be activated may be notified.

The boot loader, which has been activated in step 406, checks if the first modules have failed in integrity check (step 407). If the boot loader detects an integrity check failure in the first modules (YES in step 408), the boot loader notifies the integrity check failure (step 419), and ends the process (END). In contrast, if the boot loader does not detect an integrity check failure in the first modules (NO in step 408), the boot loader activates the first modules (step 409).

The first modules, which have been activated in step 409, transmit a primary response signal to the telephone exchange 30, as a process of responding to the CAR signal from the telephone exchange 30 (step 410). After that, the first modules receive a modem signal transmitted from the telephone exchange 30 (step 411), and transmit a reception completion signal to the telephone exchange 30 (step 412). Then, the first modules checks if the second modules have failed in integrity check (step 413). If the first modules detect an integrity check failure in the second modules (YES in step 414), the first modules notify the integrity check failure (step 419), and end the process (END). In contrast, if the first modules do not detect an integrity check failure in the second modules (NO in step 414), the first modules activate the second modules (step 415).

If the second modules, which have been activated in step 415, detect arrival of an IR signal from the telephone exchange 30 (YES in step 416), the second modules transmit a secondary response signal to the telephone exchange 30, as a response process (step 417), and start reception of a facsimile document (step 418). In contrast, if the second modules do not detect arrival of an IR signal from the telephone exchange 30 (NO in step 416), the second modules repeatedly perform the determination process in step 416 until arrival of an IR signal is detected.

### Concrete Example

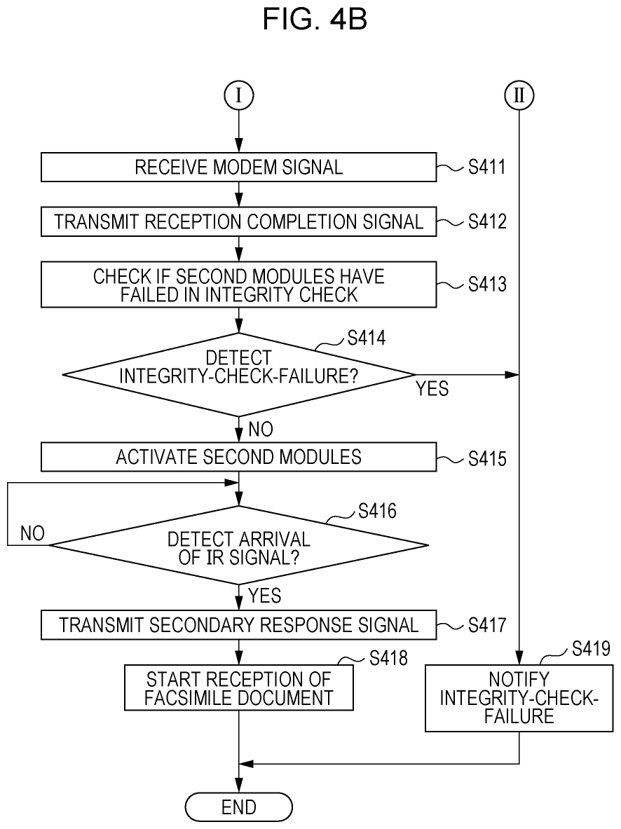

FIG. 5 is a diagram illustrating a concrete example of timing of reception/transmission of various signals, which is performed until reception/transmission of a facsimile document is started between the image processing apparatus 10 and the telephone exchange 30.

At a time at which 0.1 seconds or more have elapsed after connection in which the polarity is reversed (polarity reversal) is established, a CAR signal is transmitted from the telephone exchange 30 to the image processing apparatus 10. Then, the image processing apparatus 10 performs the following processes (not illustrated) in this order: checking if the boot loader has failed in integrity check; activating the boot loader; checking if the first modules have failed in integrity check; and activating the first modules. Then, a primary response signal is transmitted from the first modules of the image processing apparatus 10 to the telephone exchange 30. The primary response signal is transmitted within six seconds, which are the time limit, after the connection in which the polarity is reversed (polarity reversal) is established.

Between 0.1 seconds and three seconds after transmission of the primary response signal from the first modules of the image processing apparatus 10, a modem signal is transmitted from the telephone exchange 30 to the image processing apparatus 10. When the first modules of the image processing apparatus 10 detect arrival of the modem signal from the telephone exchange 30, the first modules transmit, to the telephone exchange 30, a reception completion signal indicating the reception. The telephone exchange 30 receives the reception completion signal which has been transmitted. The time from the telephone exchange 30's transmission of the modem signal until the telephone exchange 30's reception of the reception completion signal is about 0.3 seconds.

When the telephone exchange 30 receives the reception completion signal from the first modules of the image processing apparatus 10, the telephone exchange 30 transmits an IR signal to the image processing apparatus 10. At that time, the image processing apparatus 10 performs the following processes (not illustrated) in this order: checking if the second modules have failed in integrity check; and activating the second modules. A secondary response signal is transmitted from the second modules to the telephone exchange 30. After connection in which the polarity is returned (polarity return) is established, communication is started. The time from the telephone exchange 30's reception of the reception completion signal until the telephone exchange 30's reception of the secondary response signal is 0.3 seconds or more.

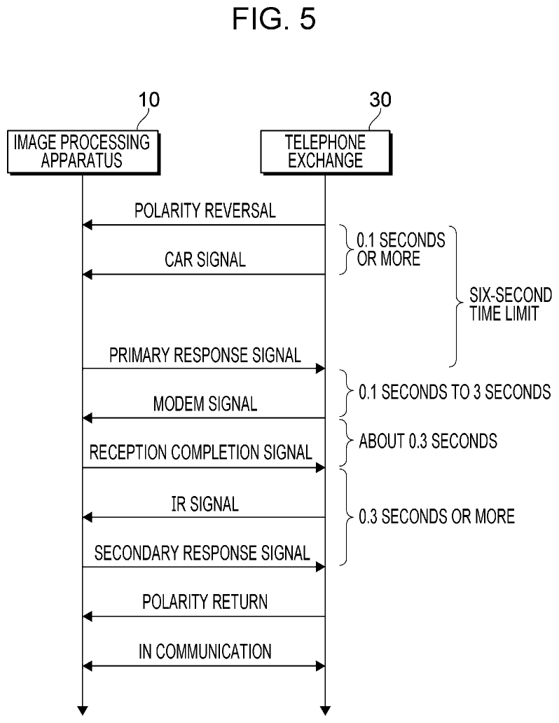

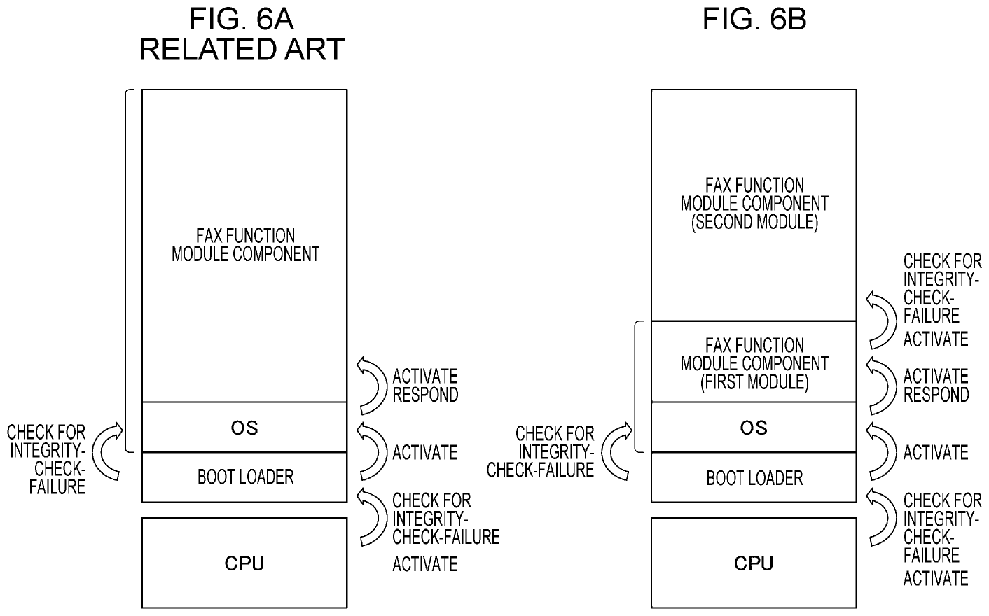

FIG. 6A is a diagram illustrating an example of the related art, in which a fax function module component, which is constituted by multiple modules, is not classified. FIG. 6B is a diagram illustrating a concrete example of the case in which a fax function module component, which is constituted by multiple modules, is classified as first modules or second modules.

The fax function module component illustrated in FIGS. 6A and 6B is constituted by multiple modules. As illustrated in FIG. 6A, in the process of the related art, in which the fax function module component is not classified, a CPU checks if the boot loader has failed in integrity check. If an integrity check failure is not detected, the boot loader is activated. The activated boot loader checks if the operating system (OS) and the fax function module component have failed in integrity check. If an integrity check failure is not detected, the boot loader activates the OS. The activated OS activates the fax function module component.

When the activated fax function module component detects arrival of a CAR signal from the telephone exchange 30, the fax function module component transmits a primary response signal to the telephone exchange 30 within a time limit. In the case of FIG. 6A, the fax function module component is not classified as first modules or second modules. Therefore, checking for an integrity check failure may take longer time than in the case in which the fax function module component is classified as first modules or second modules, and a primary response signal may fail to be transmitted within the time limit from the fax function module component to the telephone exchange 30.

In contrast, in the present exemplary embodiment, the fax function module component is classified as first modules or second modules. As illustrated in FIG. 6B, the activated boot loader checks if the OS and the first modules have failed in integrity check. If an integrity check failure is not detected, the boot loader activates the OS. The activated OS activates the first modules. When the activated first modules detect arrival of a CAR signal from the telephone exchange 30, the first modules transmit a primary response signal to the telephone exchange 30 within the time limit.

The fax function module component is classified as first modules or second modules. Thus, compared with the case in which the fax function module component is not classified as first modules or second modules, checking for an integrity check failure does not take time. Therefore, the first modules may transmit a primary response signal to the telephone exchange 30 within the time limit. After transmission of the primary response signal, the first modules receive a modem signal from the telephone exchange 30, and transmit a reception completion signal to the telephone exchange 30. After that, the first modules check if the second modules have failed in integrity check. If the first modules do not detect an integrity check failure, the first modules activate the second modules. Since no time limits are set to the processes performed by the second modules, activation of the second modules may be performed after the processes performed by the first modules.

### Other Exemplary Embodiments

The present exemplary embodiment is described above. However, the present disclosure is not limited to the exemplary embodiment described above. Effects of the present disclosure are not limited to those described in the exemplary embodiment described above. For example, the configuration of the information processing system 1, which is illustrated in FIG. 1, and the hardware configuration of the image processing apparatus 10, which is illustrated in FIG. 2, are merely examples for achieving the object of the present disclosure, and are not particularly limited. The functional configuration of the image processing apparatus 10, which is illustrated in FIG. 3, is merely an example, and is not particularly limited. The configuration may be any as long as the function, in which the processes described above may be performed as a whole, is included in the information processing system 1 in FIG. 1. Which functional configuration is employed to achieve the function is not limited to the example in FIG. 3.

The order of steps in the process of the image processing apparatus 10, which is illustrated in FIGS. 4A and 4B, is merely an example, and is not particularly limited. Not only the processes performed in a time series according to the illustrated order of steps, but also processes performed in parallel or individually, not necessarily in a time series, may be employed. The concrete examples illustrated in FIGS. 5 to 6B are merely examples, and are not particularly limited.

In the exemplary embodiment described above, a “predetermined process” is a process of responding to the telephone exchange 30 (see FIG. 1), but is not limited to this. Any process which may be required to be performed within a time limit is encompassed in the “predetermined process”.

In the exemplary embodiment described above, the first modules and the second modules perform their different processes. However, this is not limited. For example, if the first modules are capable of performing a response process within a time limit, the first modules may perform at least some of the second modules.

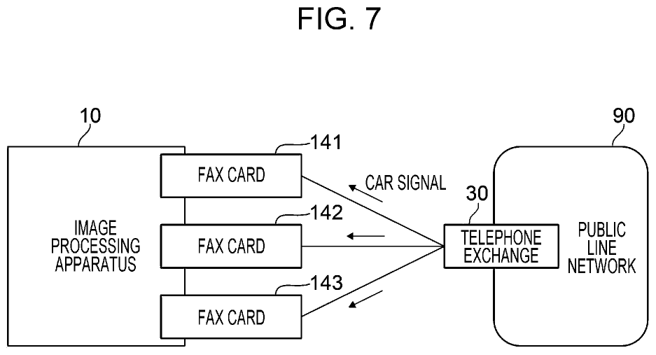

In the exemplary embodiment described above, the example in which a single fax card is included in the image processing apparatus 10 is described. However, the configuration is not limited to this. Multiple fax cards may be included in the image processing apparatus 10. FIG. 7 is an image view of a concrete example of the case in which multiple fax cards are included in the image processing apparatus 10.

In the example in FIG. 7, three fax cards 141 to 143 are included in the image processing apparatus 10. In this case, for example, when a CAR signal is transmitted from the telephone exchange 30, which is on a public line network (network 90), to the fax card 141, the fax card 141 does not wait for the power supply of the other fax cards 142 and 143 to be turned ON, and starts checking if the boot loader has failed in integrity check.

The same is true for the case in which CAR signals are transmitted from the telephone exchange 30 to the respective fax cards 142 and 143. That is, when a CAR signal is transmitted from the telephone exchange 30 to either one of the fax cards 142 and 143, the fax card 142 or 143 does not wait for the power supply of the other fax cards to be turned ON, and starts checking if the boot loader has failed in integrity check.

When multiple fax cards are included in the image processing apparatus 10, for example, switching from a fax card, in which an integrity check failure is detected, to a fax card, in which an integrity check failure is not detected, may be performed so that the transmission is restored. For example, in the example in FIG. 7, assume the case in which an integrity check failure is detected in the fax card 141, and in which an integrity check failure is not detected in the fax card 142. In this case, switching from the fax card 141 to the fax card 142 may restore the transmission.

In the case where the image processing apparatus 10 supports parallel execution of multiple processes, the processes performed by the first modules and the processes performed by the second modules may be performed in parallel. However, in this case, after the first modules perform predetermined processes within a time limit, checking if the second modules have failed in integrity check may be performed. Specifically, for example, arrival of a CAR signal from the telephone exchange 30 is detected, and the first modules transmit a primary response signal within a time limit. Then, the first modules receive a modem signal from the telephone exchange 30, and transmit a reception completion signal to the telephone exchange 30. After that, the first modules may check if the second modules have failed in integrity check.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or more processors configured to:
   classify a plurality of modules as at least one first module or at least one second module, the plurality of modules being included in the information processing apparatus, the at least one first module being required to perform a predetermined process within a predetermined time after activation triggered by reception of a signal from an outside, the at least one second module being not required to perform the process within the time; and
   after completion of confirming that the at least one first module does not fail in integrity check and the at least one first module performing the process, confirm that the at least one second module does not fail in integrity check.
      (((2)))

The information processing system according to (((1))),
wherein the at least one first module is a module required to perform, within the time, a response process as the process.
   (((3)))

The information processing system according to (((2))),
wherein the information processing apparatus is an image processing apparatus,
wherein the signal from the outside is an information-receiving-terminal activation signal from a telephone exchange, and
wherein the response process is a process in which the at least one first module transmits a primary response signal to the telephone exchange.
   (((4)))

The information processing system according to (((3))),
wherein the one or more processors are configured to:
   when at least one fax card is included in the image processing apparatus, the at least one fax card being hardware for receiving/transmitting a facsimile signal, classify firmware of the at least one fax card as a boot loader, the at least one first module, or the at least one second module, the boot loader activating an operating system.
      (((5)))

The information processing system according to (((4))),
wherein the one or more processors are configured to:
   in response to power supply of the at least one fax card being turned ON due to arrival of the information-receiving-terminal activation signal, after completion of confirming that the boot loader does not fail in integrity check, confirming that the at least one first module does not fail in integrity check, and the at least one first module transmitting the primary response signal, confirm that the at least one second module does not fail in integrity check.
      (((6)))

The information processing system according to (((5))),
wherein the at least one fax card comprises a plurality of fax cards,
wherein the one or more processors are configured to:
   for each of the plurality of fax cards, after completion of confirming that the boot loader does not fail in integrity check, confirming that the at least one first module does not fail in integrity check, and the at least one first module transmitting the primary response signal, confirm that the at least one second module does not fail in integrity check.
      (((7)))

The information processing system according to any of (((1))) to (((6))),
wherein the plurality of modules include a switching-settable module for which switching between execution of the process and non-execution of the process is settable.
   (((8)))

The information processing system according to (((7))),
wherein the one or more processors are configured to:
   classify the switching-settable module as the at least one first module or the at least one second module on a basis of a state of the switching setting.
      (((9)))

A program causing a computer to execute a process comprising:
classifying a plurality of modules as at least one first module or at least one second module, the plurality of modules being included in an information processing apparatus, the at least one first module being required to perform a predetermined process within a predetermined time after activation triggered by reception of a signal from an outside, the at least one second module being not required to perform the process within the time; and
after completion of confirming that the at least one first module does not fail in integrity check and the at least one first module performing the process, confirming that the at least one second module does not fail in integrity check.

What is claimed is:

1. An information processing system comprising:
one or more processors configured to:
classify a plurality of modules as at least one first module or at least one second module, the plurality of modules being included in the information processing apparatus, the at least one first module being required to perform a predetermined process within a predetermined time after activation triggered by reception of a signal from an outside, the at least one second module being not required to perform the process within the time; and
after completion of confirming that the at least one first module does not fail in integrity check and the at least one first module performing the process, confirm that the at least one second module does not fail in integrity check.

2. The information processing system according to claim 1,
wherein the at least one first module is a module required to perform, within the time, a response process as the process.

3. The information processing system according to claim 2,
wherein the information processing apparatus is an image processing apparatus,
wherein the signal from the outside is an information-receiving-terminal activation signal from a telephone exchange, and
wherein the response process is a process in which the at least one first module transmits a primary response signal to the telephone exchange.

4. The information processing system according to claim 3,
wherein the one or more processors are configured to:
when at least one fax card is included in the image processing apparatus, the at least one fax card being hardware for receiving/transmitting a facsimile signal, classify firmware of the at least one fax card as a boot loader, the at least one first module, or the at least one second module, the boot loader activating an operating system.

5. The information processing system according to claim 4,
wherein the one or more processors are configured to:
in response to power supply of the at least one fax card being turned ON due to arrival of the information-receiving-terminal activation signal, after completion of confirming that the boot loader does not fail in integrity check, confirming that the at least one first module does not fail in integrity check, and the at least one first module transmitting the primary response signal, confirm that the at least one second module does not fail in integrity check.

6. The information processing system according to claim 5,
wherein the at least one fax card comprises a plurality of fax cards,
wherein the one or more processors are configured to:
for each of the plurality of fax cards, after completion of confirming that the boot loader does not fail in integrity check, confirming that the at least one first module does not fail in integrity check, and the at least one first module transmitting the primary response signal, confirm that the at least one second module does not fail in integrity check.

7. The information processing system according to claim 1,
wherein the plurality of modules include a switching-settable module for which switching between execution of the process and non-execution of the process is settable.

8. The information processing system according to claim 7,
wherein the one or more processors are configured to:
classify the switching-settable module as the at least one first module or the at least one second module on a basis of a state of the switching setting.

9. A non-transitory computer readable medium storing a program causing a computer to execute a process comprising:
classifying a plurality of modules as at least one first module or at least one second module, the plurality of modules being included in an information processing apparatus, the at least one first module being required to perform a predetermined process within a predetermined time after activation triggered by reception of a signal from an outside, the at least one second module being not required to perform the process within the time; and
after completion of confirming that the at least one first module does not fail in integrity check and the at least one first module performing the process, confirming that the at least one second module does not fail in integrity check.

10. A method comprising:
classifying a plurality of modules as at least one first module or at least one second module, the plurality of modules being included in an information processing apparatus, the at least one first module being required to perform a predetermined process within a predetermined time after activation triggered by reception of a signal from an outside, the at least one second module being not required to perform the process within the time; and
after completion of confirming that the at least one first module does not fail in integrity check and the at least one first module performing the process, confirming that the at least one second module does not fail in integrity check.
